(19) United States
(12) Patent Application Publication
(10) Pub. No.: US 2024/0104674 A1
(43) Pub. Date: Mar. 28, 2024

(54) INFORMATION PROCESSING APPARATUS, INFORMATION PROCESSING SYSTEM, AND INFORMATION PROCESSING METHOD

(71) Applicant: Toshiba Tec Kabushiki Kaisha, Tokyo (JP)

(72) Inventors: Atsushi NAKANISHI, Chofu Tokyo (JP); Daisuke NARAZAKI, Ota Tokyo (JP); Hiroshi SAWA, Numazu Shizuoka (JP); Yoshinori ANZAI, Katsushika Tokyo (JP)

(21) Appl. No.: 18/366,633

(22) Filed: Aug. 7, 2023

(30) Foreign Application Priority Data
Sep. 22, 2022 (JP) 2022-151660

(51) Int. Cl. G06Q 50/12; G06F 3/14; G06Q 10/0832; G09G 5/02

(52) U.S. Cl. CPC G06Q 50/12; G06F 3/14; G06Q 10/0832; G09G 5/02

(57) ABSTRACT

According to an embodiment, an information processing apparatus has a first interface connectable to an external server, a second interface connectable to a display, and a processor. The processor is configured to receive order data for dinning orders via the first and second interface and cause the display to display order data in a first area or a second area depending on whether the order data is first-type order data or second-type order data. The first and second areas are separate areas. The first-type order data is for dining orders of a first type, such as delivery orders, and the second-type order data is for dining orders of a second type, such as in-store dining orders.

### CROSS-REFERENCE TO RELATED APPLICATION

This application is based upon and claims the benefit of priority from Japanese Patent Application No. 2022-151660, filed Sep. 22, 2022, the entire contents of which are incorporated herein by reference.

### FIELD

Embodiments described herein relate generally to an information processing apparatus, an information processing system, and an information processing method.

### BACKGROUND

In recent years, in the restaurant industry, the demand for delivery services and take-out services has increased, and the number of restaurants that provide these services is increasing. In these restaurants, orders for in-store dining, orders for delivery, and orders for take-out are generally mixed in intake sequence, and thus these orders are displayed in a mixed manner on a kitchen display used to manage and track these orders.

For an order for delivery or an order for take-out, a delivery person or a consumer may request to come to pick up a commodity at a preset time, and it may be necessary to preferentially deal with some orders no matter the intake sequence.

However, since the orders for delivery take-out are displayed and managed in the same manner as, and mixed with, the orders for in-store dining, thus it takes time and effort for store staff to identify the orders for delivery or take-out, and such orders may be overlooked or omitted.

Therefore, there is a demand for a technological solution for improving the displaying and managing of orders for restaurants.

### BRIEF DESCRIPTION OF THE DRAWINGS

FIG. 1 is a block diagram showing an information processing system according to an embodiment.

FIG. 2 is a block diagram showing a store server.

FIG. 3 is a diagram showing a data structure of order data.

FIG. 4 is a diagram showing an example of an order display image displayed on a display.

FIG. 5 is a diagram showing an example of an order image.

FIG. 6 is a diagram showing an example of an order image.

FIG. 7 is a diagram showing an example of a display setting image.

FIG. 8 is a diagram showing an example of a slip printed by a printer according to the embodiment.

FIG. 9 is a flowchart showing an example of order displaying executed by the store server.

FIG. 10 is a flowchart showing an example of order display updating.

### DETAILED DESCRIPTION

In general, according to one embodiment, a technological solution to existing problems in kitchen order tracking systems, or the like, used for displaying orders of different types is provided. An embodiment displays different orders such that the orders can be visually distinguished according to type. That is, an embodiment represents a technological improvement to existing order management systems for restaurant kitchens and the like.

According to an embodiment, an information processing apparatus includes a first interface connectable to an external server, a second interface connectable to a display, and a processor. The processor is configured to receive order data for dinning orders via the first and second interface and cause the display to display order data in a first area or a second area depending on whether the order data is first-type order data or second-type order data. The first and second areas are separate areas. The first-type order data includes dining orders of a first type. The second-type order data includes dining orders of a second type. The second type is different from the first type.

Hereinafter, certain example embodiments will be described with reference to the drawings. In the drawings, the same components are denoted by the same reference symbols, and redundant description thereof may be omitted in discussion of subsequent figures and/or embodiments.

### Configuration Example

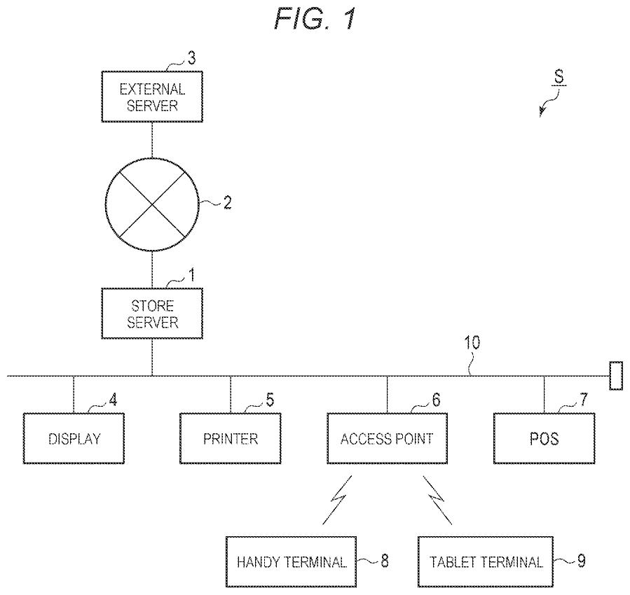

FIG. 1 is a block diagram showing an information processing system S.

The information processing system S handles orders for a dining establishment, restaurant, or the like. The information processing system S acquires (receives) an order for dining via an external server 3, a point of sales (POS) terminal 7, a handy (handheld) terminal 8, or a tablet terminal 9, and displays information about the order for dining on a display 4.

The information processing system S includes store server 1, external server 3, display 4, printer 5, access point 6, POS terminal 7, handy terminal 8, and tablet terminal 9. The store server 1, the display 4, the printer 5, the access point 6, and the POS terminal 7 are communicably connected to one another via a network 10. For example, the network 10 is a local area network (LAN). The network 10 may include or be a wireless network or a wired network. The store server 1 and the external server 3 are communicably connected to each other via a network 2. For example, the network 2 is the Internet. The network 2 may include or be a wireless network or a wired network.

Although one display 4 is shown in FIG. 1, the information processing system S may include a plurality of displays 4. Although one handy terminal 8 is shown in FIG. 1, the information processing system S may include a plurality of handy terminals 8. Although one tablet terminal 9 is shown in FIG. 1, the information processing system S may include a plurality of tablet terminals 9. Although one access point 6 is shown in FIG. 1, the information processing system S may include a plurality of access points 6. Although one POS terminal 7 is shown in FIG. 1, the information processing system S may include a plurality of POS terminals 7. The information processing system S may also refer to any system including at least two electronic devices such as the store server 1 and the display 4.

The store server 1 is an electronic device capable of information processing for managing an order for dining. The store server 1 is an example of an information processing apparatus. In the following description, a “store” or a “shop” may be referred to as a “restaurant”.

The external server 3 is an electronic device that collects data and processes the collected data. The external server 3 is communicably connected to the store server 1 via the network 2. The external server 3 receives various data from the store server 1 and outputs various data to the store server 1. The external server 3 manages order data including an ordered item for each store acquired from a mobile terminal or the like of a customer. In the following description, the order data can also be referred to more simply as an order. The “item” ordered may be referred to as, “order item,” “ordered item,” “menu item,” “commodity” or “food and drink”.

The display 4 is an electronic device installed in a store and capable of displaying an image based on the order data. The display 4 is an example of a display unit.

The printer 5 is, for example, a thermal printer or a dot impact printer, and is an electronic device capable of printing, on a medium such as paper, information such as various character strings (text) and images based on print data.

The access point 6 is an electronic device capable of communicating with the handy terminal 8 or the tablet terminal 9.

The POS terminal 7 is, for example, an electronic device to which order data can be input and that executes settlement for an ordered item by an operation of a store staff. The store staff is an example of a user.

The handy terminal 8 is, for example, an electronic device to which order data can be input by an operation of store staff.

The tablet terminal 9 is, for example, an electronic device to which order data can be input by an operation of the customer. For example, the tablet terminal 9 is installed in a store in association with a table or booth.

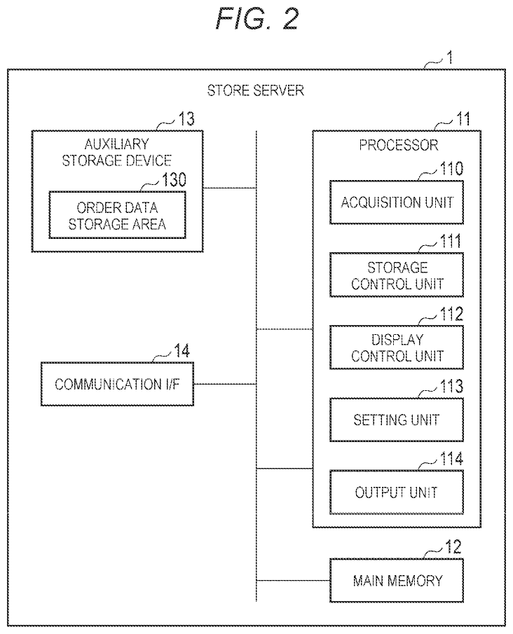

FIG. 2 is a block diagram showing the store server 1.

The store server 1 includes a processor 11, a main memory 12, an auxiliary storage device 13, and a communication interface 14. In FIG. 2, the interface is described as “I/F”. The processor 11 corresponds to a central part of the store server 1. The processor 11 is an element constituting a computer of the store server 1. For example, the processor 11 can be a central processing unit (CPU), but is not limited thereto. The processor 11 may include various other circuits. The processor 11 is an example of a processing circuit of the store server 1. The processor 11 executes a program stored in the main memory 12 or the auxiliary storage device 13 12. The program is software instructions or the like for causing the processor 11 of the store server 1 to implement various functions and processes. The processor 11 executes various processes by executing programs loaded into the main memory 12.

The main memory 12 corresponds to a main storage portion of the store server 1. The main memory 12 is an element constituting the computer of the store server 1. The main memory 12 includes a non-volatile memory area and a volatile memory area. The main memory 12 stores an operating system or a program in the non-volatile memory area. The main memory 12 uses the volatile memory area as a work area where data is appropriately rewritten by the processor 11. For example, the main memory 12 includes a read only memory (ROM) as the non-volatile memory area. For example, the main memory 12 includes a random access memory (RAM) as the volatile memory area.

The auxiliary storage device 13 corresponds to an auxiliary storage portion of the store server 1. The auxiliary storage device 13 is an element constituting the computer of the store server 1. The auxiliary storage device 13 is an electric erasable programmable read-only memory (EEPROM®), a hard disc drive (HDD), a solid-state drive (SSD), or the like. The auxiliary storage device 13 may store programs, data used by the processor 11 to execute various processes, and data generated by the processor 11. The auxiliary storage device 13 is an example of a storage unit.

The auxiliary storage device 13 includes an order data storage area 130. The order data storage area 130 stores order data. The order data is data about an order for dining. The order data includes data such as an order ID, a table number, a delivery number, a commodity name, a customer count, an order time, and a delivery time. The order ID is a unique code set for each order to individually identify the order. The table number is a unique code set for identifying the customer who orders at a table in the store or the like. The table number is, for example, identification information indicating the table at which the customer sits when the customer dines in the store. The table number may be identification information different from the identification information indicating the table when the customer does not dine in the store. The table number may be a code that identifiably indicates whether the customer dines inside the restaurant or is a take-way or delivery order.

When the order data is an order for delivery, the delivery number is a unique code set for each order for delivery to individually identify the order for delivery. The delivery number indicates identification information unique to the order for delivery. The order for delivery is also referred to as a delivery order. The delivery order is an order for the customer using a user terminal or the like to connect to a delivery reservation service via the Internet or the like and receive, by delivery, an ordered item input via the delivery reservation service. The store that receives the delivery order packs the ordered item for delivery and passes the packed ordered item to a delivery person. The delivery person delivers the ordered item to a place designated by the customer. The delivery may be referred to as “distribution”.

When the order data is an order for take-out, the delivery number is a unique code set for each order for take-out to individually identify the order for take-out. The delivery number indicates identification information unique to the order for take-out. The order for take-out is also referred to as a take-out order. A take-out order is an order for the customer to visit the store and take out an ordered item. Such a take-out may also be referred to as “take-away”. A take-out order can be an order for a first-type take-out (first take-out) and an order for a second-type take-out (second take-out). An order for first-type take-out is also referred to as a first take-out order. The first take-out is a mode in which the customer visits the store after submitting an ordered item via a take-out reservation service using a user terminal or the like and then takes out the ordered item. In the first take-out order, the customer uses a user terminal or the like to connect to the take-out reservation service via the Internet or the like, and inputs the ordered item via the take-out reservation service. Order data for the first-type take-out order is data on the ordered item input by the customer via the take-out reservation service. An order for second-type take-out is also referred to as a second-type take-out order. A second take-out is a mode in which the customer orders at the store and then takes out an ordered item. For example, in the second take-out order, the store staff inputs the ordered item for the customer by using the POS terminal 7. Order data for the second take-out order is data on the ordered item ordered for take-out using an electronic device in the store. The store that receives a first-type take-out order or a second-type take-out order packs the ordered item for take-out and then passes the packed ordered item to the customer. In the following description, a “take-out order” may be either or both a first-type take-out order or a second-type take-out order.

When the order data is an order for in-store dining, the delivery number may be information indicating that a delivery number is not assigned, such as “N/A”. The order for in-store dining is also referred to as an in-store dining order. The in-store dining order is an order for in-store dining after the customer visits the store. The delivery number may be a code that identifiably indicates a delivery order or a take-out order. The delivery number may be a code that identifiably indicates a delivery order, a take-out order, or an in-store dining order.

The commodity name is information capable of identifying each ordered item. The customer count is information indicating the number of customers who are part of the same order when the customers dine in the store. In a case of the delivery order or the take-out order, the customer count may be information indicating that there is no information on the customer count, such as “N/A”. The order time is the time when an order is received.

When the order data is a delivery order, the delivery time is a time when the delivery person is expected to come to the store to pick up an ordered item. The delivery time is also referred to as a pickup time. The delivery time may be the time when the ordered item is expected to be delivered to the customer. When the order data is a take-out order, the delivery time is a time when the store staff is expected to pass an ordered item to the customer at the store. In this case, the delivery time may be referred to as a take-out time.

The communication interface 14 includes various interfaces for communicably connecting the store server 1 to other electronic devices via the network 10 according to a predetermined communication protocol. The communication interface 14 includes various interfaces for communicably connecting the store server 1 to other electronic devices via the network 2 according to a predetermined communication protocol.

A hardware configuration of the store server 1 is not limited to the above configuration. Omission and modification of the above components and addition of new components as appropriate in the store server 1 are possible.

The processor 11 implements an acquisition unit 110, a storage control unit 111, a display control unit 112, a setting unit 113, and an output unit 114. Each unit implemented by the processor 11 may also be referred to as each function. It can also be said that each unit implemented by the processor 11 is implemented by a control unit including the processor 11 and the main memory 12.

The acquisition unit 110 acquires order data from the external server 3 via the network 2. The order data includes data on an ordered item input by the customer via a user terminal or the like. The order data may be for a delivery order or for a first take-out order.

The acquisition unit 110 acquires an order for dining (order data) from the handy terminal 8, the tablet terminal 9, or the POS terminal 7 via the network 10. The order data includes data indicating an ordered item as input by the store staff or the customer via the handy terminal 8, the tablet terminal 9, or the POS terminal 7. The order data may be for an in-store dining order or a second-type take-out order. The order data may include an order in which an in-store dining order and a second-type take-out order are mixed. Any order in which the in-store dining order and the second-type take-out order are mixed is also referred to as a mixed order.

The order data may be different data depending on dining types. The dining type includes in-store dining, delivery, take-out, and a mixture of the in-store dining order and the second take-out order. The in-store dining is a dining type in which an ordered item is eaten or drunk in the store. The delivery is a dining type in which an ordered item is delivered to the customer. The take-out is a dining type in which the customer takes out an ordered item from the store. The first take-out and the second take-out may be the same dining type or different dining types. The mixture of the in-store dining order and the second take-out order is a dining type of mixing the dining type in which an ordered item is eaten or drunk in the store, and the dining type in which the customer takes out an ordered item from the store.

The order data for an in-store dining order is an example of first order data. The first order data is order data about a first dining type. The first dining type is in-store dining in this example. The order data for a delivery order is an example of second order data. The second order data is order data about a second dining type. The second dining type is delivery in this example. The order data for a take-out order or the order data for a mixed order is an example of third order data. The third order data is order data about a third dining type. The third dining type may be take-out or may be a mixture of an in-store dining order and a take-out order.

The storage control unit 111 stores the order data in the order data storage area 130 of the auxiliary storage device 13. The storage control unit 111 may store the order data for the delivery order, the take-out order, the in-store dining order, and the mixed order in different storage areas or in the same storage area.

The display control unit 112 displays an image based on the order data in different areas depending on whether the order data is the first order data or the second order data. The image based on the order data is also referred to as an order image. The different areas include a first area and a second area in at least one display 4. The first area and the second area may be different areas in the same display 4 or may be two different displays 4. The display control unit 112 displays an image based on the first order data in the first area and displays an image based on the second order data in the second area. The image based on the first order data is an example of the order image. The image based on the second order data is an example of the order image. The display control unit 112 may display the image based on the first order data and the image based on the second order data in different areas based on a user setting set according to an instruction of the user.

The display control unit 112 displays the order image displayed in the first area or the second area in a display mode in which a dining type is identifiable. The display control unit 112 displays the order image on the display 4. The display control unit 112 may display the order image displayed in the first area and the order image displayed in the second area in different display modes according to the dining type. In this context, differences in display modes include visual differences in character color, font size, font type, typefaces, highlighting, display region differences such as brightness or luminance variations, background colors, brightness or luminance of backgrounds, background patterns, a frame color, a blinking display, or the like. For example, the display control unit 112 may cause the first area and the second area to have different background colors. The display control unit 112 may also or instead include unique identification information for the order data. For example, when the order data is a delivery order, the display control unit 112 displays an order image including a delivery number.

The display control unit 112 displays an image based on the third order data in the first area or the second area based on the instruction of the user (that is, a user setting selection or preference). The display control unit 112 may display the image based on the third order data in a display mode identifiable from the image based on the first order data and the image based on the second order data. The image based on the third order data is an example of the order image.

The display control unit 112 hides the order image based on an update instruction of the user.

The setting unit 113 sets, based on the instruction of the user, areas for displaying the image based on the first order data, the image based on the second order data, and the image based on the third order data. The setting unit 113 may make setting in advance so as to display the image based on the first order data in the first area and display the image based on the second order data in the second area. The setting unit 113 may make setting so as to display the image based on the third order data in the first area or the second area based on the instruction of the user.

The output unit 114 outputs, to the printer 5, print data based on the order data. The print data includes a printing date and time, a slip number, a table number, a customer count, a delivery number, a commodity name of an ordered item, and the like. The output unit 114 may output, based on the update instruction of the user, the print data based on the order data to the printer 5 in response to the update of the order image.

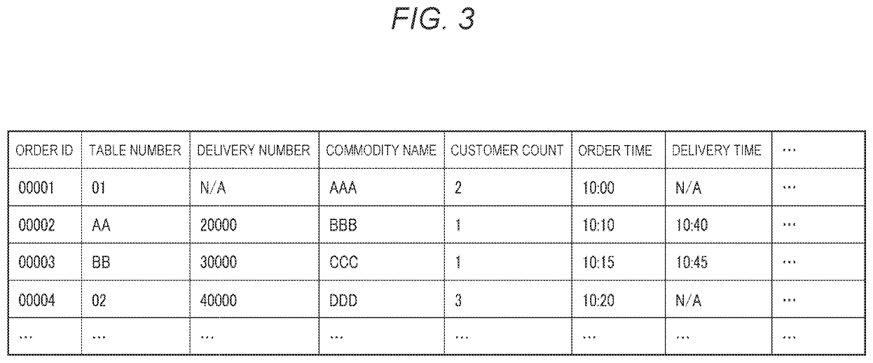

A configuration example of the order data stored in the order data storage area 130 will be described. FIG. 3 is a diagram showing a data structure of the order data.

The order data includes order data in which an order ID, a table number, a delivery number, a commodity name, a customer count, an order time, a delivery time, and the like are associated with one another. The order data may include information indicating a dining type.

For example, an order with an order ID “00001” is an in-store dining order. For the order with the order ID “00001”, the table number is “01”, the delivery number is “N/A”, the commodity name is “AAA”, the customer count is “2”, the order time is “10:00”, and the delivery time is “N/A”. Since the order with the order ID “00001” is the in-store dining order, the delivery number and the delivery time are not provided. It is understood that the customer who orders with the order ID “00001” sits at a table indicated by the table number “01” and eats or drinks an ordered item with the commodity name “AAA”. Although only one commodity name is shown in FIG. 3, commodity names are added to order data according to the number of ordered items.

An order with an order ID “00002” is a delivery order. For the order with the order ID “00002”, the table number is “AA”, the delivery number is “20000”, the commodity name is “BBB”, the customer count is “1”, the order time is “10:10”, and the delivery time is “10:40”. Since the order with the order ID “00002” is the delivery order, the table number includes information in a format different from that of the table number of the in-store dining order. The order with the order ID “00002” is identifiable from the in-store dining order by the delivery number. The delivery number may be assigned by the delivery reservation service that receives the delivery order. It is understood that the customer with the order ID “00002” wants delivery at the delivery time “10:40”. The store staff prepares an ordered item indicated by the order data with the order ID “00002” in time for the delivery time. When the delivery time is a pickup time, the store staff prepares the ordered item indicated by the order data with the order ID “00002” such that the item can be passed to the delivery person at the pickup time.

An order with an order ID “00003” is a first take-out order. For the order with the order ID “00003”, the table number is “BB”, the delivery number is “30000”, the commodity name is “CCC”, the customer count is “1”, the order time is “10:15”, and the delivery time is “10:45”. Since the order with the order ID “00003” is the first take-out order, the table number includes information in a format different from that of the table number of the in-store dining order. The table number may include information in the same format as that of the table number of the delivery order. The order with the order ID “00003” is identifiable from the in-store dining order by the delivery number. The delivery number may be assigned by the take-out reservation service that receives the first take-out order. The delivery number may be a receipt number. The delivery number may be information in a format different from that of the delivery number of the delivery order. It is understood that the customer with the order ID “00003” wants to take out at the delivery time “10:45”. In this case, the delivery time may be referred to as a take-out time or a pickup time. The store staff prepares an ordered item indicated by the order data with the order ID “00003” in time for the take-out time.

An order with an order ID “00004” is a second take-out order. For the order with the order ID “00004”, the table number is “02”, the delivery number is “40000”, the commodity name is “DDD”, the customer count is “3”, the order time is “10:20”, and the delivery time is “N/A”. Since the order with the order ID “00004” is the second take-out order made in the store, the table number may be information in the same format as that of the table number of the in-store dining order or information in a format different from that of the table number of the in-store dining order. For example, when the order with the order ID “00004” is a mixed order including an ordered item of the in-store dining order and an ordered item of the second take-out order, the table number may be information in the same format as that of the table number of the in-store dining order. The order with the order ID “00004” is identifiable from the in-store dining order by the delivery number. The delivery number may be assigned by the terminal that receives the second take-out order in the store. The delivery number may be a receipt number. The delivery number may be information in a format different from that of the delivery number of the delivery order. The delivery time may be referred to as a take-out time. It is understood that the customer with the order ID “00004” does not designate the take-out time.

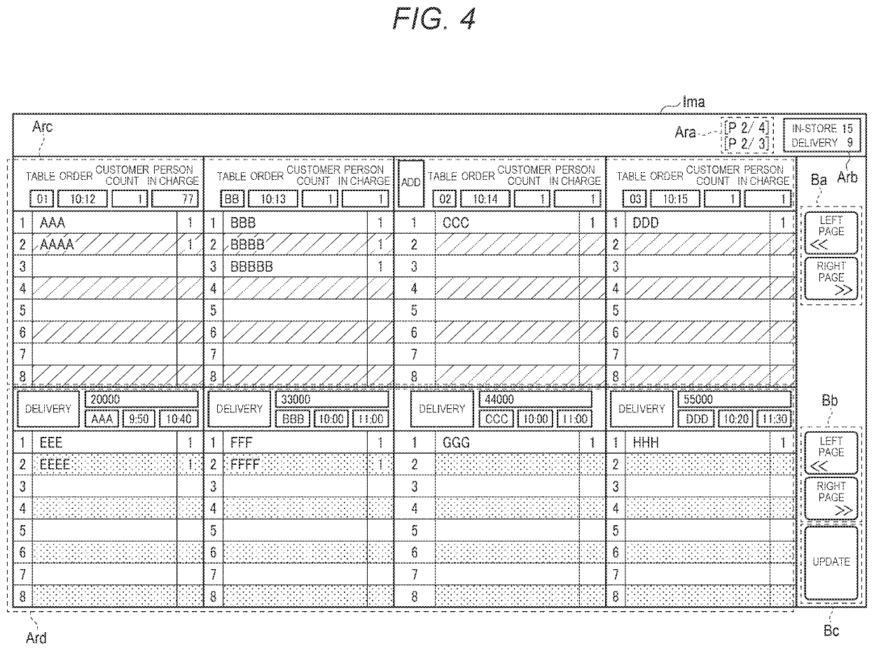

A display example of an order display image displayed on the display 4 will be described. FIG. 4 is a diagram showing the example of the order display image displayed on the display 4 according to the embodiment.

FIG. 4 shows an order display image Ima including order images based on in-store dining orders in an upper part of the image and order images based on delivery orders in a lower part of the image. The order image based on the order data for an in-store dining order can also be referred to as an order image of an in-store dining order. The order image based on the order data for a delivery order can also be referred to as an order image of a delivery order. In this example, the order images of the in-store dining orders are provided in the upper part of the order display image Ima, and the order images of the delivery orders are provided in the lower part of the order display image Ima. The upper part of the order display image Ima is an example of the first area. The lower part of the order display image Ima is an example of the second area.

The order display image Ima includes a page count display area Ara, an order count display area Arb, an in-store dining order display area Arc, and a delivery order display area Ard. The order display image Ima includes an upper part page turn button Ba, a lower part page turn button Bb, and an update button Bc.

The page count display area Ara shows the page count for each of the upper part and the lower part in the order display image Ima. In this example, the page count display area Ara shows that the page count in the upper part is four (4) in total and, among these, the second page is displayed. In addition, the page count display area Ara shows that the page count in the lower part is three (3) in total and, among these, the second page is displayed. The order count display area Arb shows the order count for each of the upper part and the lower part in the order display image Ima. In this example, the order count display area Arb shows that the order count, namely the in-store dining orders, shown in the upper part is fifteen (15) and the order count, namely the delivery orders shown, in the lower part is nine (9).

The in-store dining order display area Arc displays the order images of the in-store dining orders. In the example in FIG. 4, the order images are displayed from left to right in a chronological order of the orders. Every time order data is acquired, the display control unit 112 displays an order image based on the order data at a right end of the last page in the in-store dining order display area Arc. The user can change a display page in the in-store dining order display area Arc by operating the upper part page turn button Ba. The display control unit 112 changes the display page in the in-store dining order display area Arc in response to an instruction of the user. The in-store dining order display area Arc is an example of the first area.

The delivery order display area Ard displays the order images of the delivery orders. In the example in FIG. 4, the order images are displayed from left to right in a chronological order of the orders, similarly to the in-store dining order display area Arc. Every time order data is acquired, the display control unit 112 displays an order image based on the order data at a right end of the last page in the delivery order display area Ard. The user can change a display page in the delivery order display area Ard by operating the lower part page turn button Bb. The display control unit 112 changes the display page in the delivery order display area Ard in response to an instruction of the user. The display control unit 112 may display the order image of the delivery order in the delivery order display area Ard in a display mode in which a dining type thereof is identifiable from that of the order image displayed in the in-store dining order display area Arc. For example, the display control unit 112 may display the delivery order display area Ard in a background color different from that of the in-store dining order display area Arc. The display control unit 112 may display, on the order image of the delivery order displayed in the delivery order display area Ard, a symbol, a mark, an icon, or the like that is identifiable from that of the order image of the in-store dining order. For example, the display control unit 112 may display a “delivery” mark on the order image of the delivery order. The “delivery” mark may be a “TO (Take Out)” mark indicating “take-out” in order to distinguish from the in-store dining. The delivery order display area Ard is an example of the second area.

The update button Bc is for updating the order images displayed in the in-store dining order display area Arc and the delivery order display area Ard. The user can update the order images by selecting the update button Bc by touch input or the like. For example, when provision of an ordered item displayed in the in-store dining order display area Arc is completed, the user selects an order image corresponding to the ordered item by touch input or the like. The user selects the update button Bc by touch input or the like. In the following description, selection of an order image and selection of the update button Bc by the user are referred to as update instructions. The update instruction may be an update instruction for order data corresponding to the order image selected by the user. The update instruction in this case includes an update instruction for each piece of order data. The update instruction may be an update instruction for order data corresponding to the ordered item selected by the user. The update instruction in this case includes an update instruction for each ordered item. The display control unit 112 hides display of the selected order image in response to the update instruction of the user. When the update instruction is an update instruction for each piece of order data, the display control unit 112 hides the order image. When the update instruction is an update instruction for each ordered item, the display control unit 112 may hide only the corresponding ordered item.

The order display image Ima including the order images of the in-store dining orders in the upper part of the image and the order images of the delivery orders in the lower part of the image is shown in the example in FIG. 4, but embodiments are not limited thereto. The order display image Ima may include order images of delivery orders in the upper part of the image, and order images of in-store dining orders in the lower part of the image. The order display image Ima may include order images of in-store dining orders and order images of take-out orders in the upper part of the image. The order display image Ima may include order images of delivery orders and order images of take-out orders in the lower part of the image. The order display image Ima may include order images of delivery orders and order images of take-out orders in the upper part of the image. The order display image Ima may include order images of in-store dining orders and order images of take-out orders in the lower part of the image. The order display image Ima may include order images for first take-out orders in the upper part of the image, and order images for second take-out orders in the lower part of the image. In other examples, the order display image Ima may include order images for first take-out orders in the lower part of the image, and order images for second take-out orders in the upper part of the image. The order image based on the order data on a first take-out order is also referred to as an order image of a first take-out order. The order image based on the order data on a second take-out order is also referred to as an order image of a second take-out order. The order display image Ima may also include order images based on order data for mixed orders in the upper part of the image. In other examples, the order display image Ima may include order images based on order data for mixed orders in the lower part of the image. The order image based on the order data for a mixed order is also referred to as an order image of a mixed order.

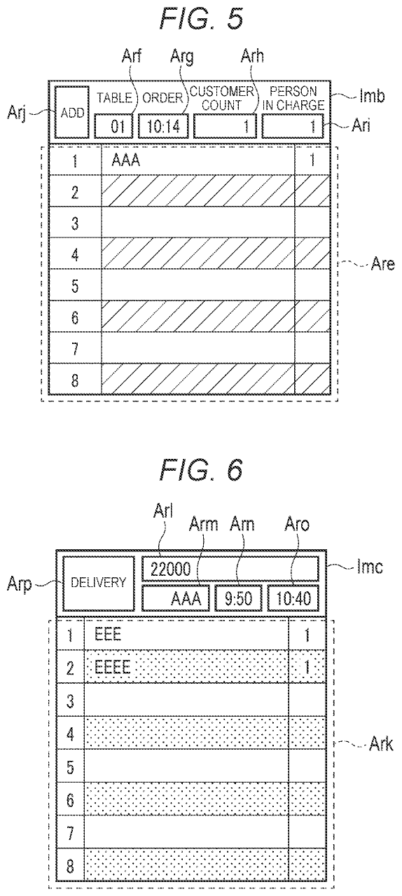

FIG. 5 is a diagram showing an example of an order image displayed on the display according to an embodiment. FIG. 5 shows an order image Imb of an in-store dining order displayed in the in-store dining order display area Arc.

The order image Imb includes an ordered item display area Are, a table number display area Arf, an order time display area Arg, a customer count display area Arh, a person in charge display area Ari, and a mark display area Arj.

The ordered item display area Are displays a commodity name of an ordered item included in order data. The ordered item display area Are may include an ordered number for each ordered item. The table number display area Arf displays a table number. The order time display area Arg displays an order time. The customer count display area Arh displays the customer count (number of customers at a table or the like). The person in charge display area Ari displays a person in charge who received the order. The mark display area Arj shows accompanying information included in the order data. The accompanying information is, for example, information indicating an additional order. In the example in FIG. 5, the mark display area Arj includes an “add” mark. The “add” mark is a mark indicating an additional order. The mark display area Arj is not limited to the depicted mark, and may also or instead display accompanying information such as a symbol or an icon in an identifiable display mode. For example, when the order data is a mixed order including an ordered item for an in-store dining order and an ordered item of a second-type take-out order, the order data may include accompanying information indicating that an ordered item of the second-type take-out order is included. In this case, the mark display area Arj may display a “TO” mark indicating the second-type take-out order.

FIG. 6 is a diagram showing an example of an order image displayed on the display 4 according to the embodiment.

FIG. 6 shows an order image Imc of a delivery order displayed in the delivery order display area Ard.

The order image Imc includes an ordered item display area Ark, a delivery number display area Arl, a table number display area Arm, an order time display area Arn, a delivery time display area Aro, and a mark display area Arp.

The ordered item display area Ark displays commodity names of ordered items included in order data. The ordered item display area Ark may include an ordered number for each ordered item. The delivery number display area Arl displays a delivery number. The table number display area Arm displays a table number. The order time display area Arn displays an order time. The delivery time display area Aro displays a delivery time. The mark display area Arp shows accompanying information included in the order data. The accompanying information is, for example, information indicating a delivery order. In the example in FIG. 6, the mark display area Arj includes a “delivery” mark. The “delivery” mark is a mark indicating a delivery order. The mark display area Arp is not limited to such a mark, and may instead or in addition display accompanying information such as a symbol or an icon in an identifiable display mode. The mark display area Arp may display the “delivery” mark when the order data is on a delivery order. For example, when the order data is a take-out order, the order data may include accompanying information indicating a take-out order. In this case, the mark display area Arp may display a “TO” mark indicating a take-out order.

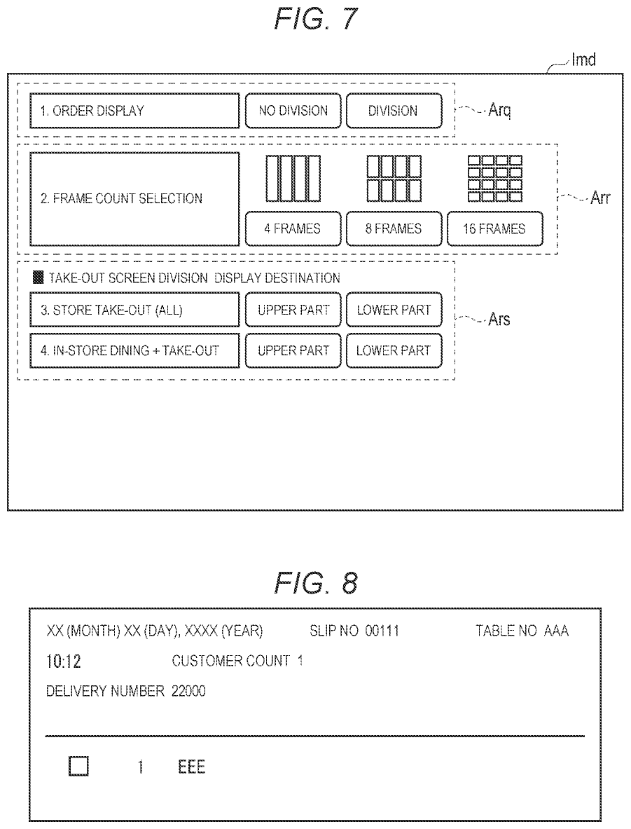

FIG. 7 is a diagram showing an example of a display setting image displayed on the display 4 according to the embodiment. FIG. 7 shows a display setting image Imd for the user to select a method for displaying order images.

The display setting image Imd includes an order display selection area Arq, a frame count selection area Arr, and a take-out order display selection area Ars. The order display selection area Arq is for the user to select whether to display the order images in different areas for respective dining types. For example, when the user selects “no division”, the setting unit 113 makes a setting so as to display the order images in the same display area regardless of the dining type. The display control unit 112 displays the order images in the same display area regardless of the dining type. When the user selects “division”, the setting unit 113 makes setting so as to display the order images in different display areas according to the dining type. The display control unit 112 displays the order images in different display areas according to the dining type.

The frame count selection area Arr is for the user to select the number of order images to be displayed on each page of the order display image. For example, when the user selects “8 frames”, the setting unit 113 makes setting so as to display order data in a total of eight order images, i.e., 2 rows×4 frames, on each page of the order display image. The display control unit 112 displays the order images based on the setting by the setting unit 113. The frame count selection area Arr includes “4 frames”, “8 frames”, and “16 frames” as selectable frame counts, but is not limited thereto. The user-selectable frame count can be appropriately set by an administrator, the user, or the like.

The take-out order display selection area Ars is for the user to select whether to display order images of take-out orders or order images of mixed orders in the upper part or the lower part of the order display image. For example, when the user selects “upper part” for “store take-out (all)”, the setting unit 113 makes setting so as to display the order images of the take-out orders in the upper part of the order display image. The display control unit 112 displays the order images of the take-out orders in the upper part of the order display image. In one example, the setting unit 113 makes a setting so as to display order images of in-store dining orders in the upper part of the order display image and order images of delivery orders in the lower part of the order display image in a divided manner. The display control unit 112 displays the order images of the take-out orders in the same area as the order images of the in-store dining orders. In this case, the display control unit 112 displays the order images of the in-store dining orders and the order images of the take-out orders in the same area in time series based on the time when the orders are received. The display control unit 112 may display the order images of the in-store dining orders and the order images of the take-out orders in an identifiable display mode. For example, the display control unit 112 may display a “TO” mark in the order image of the take-out order.

When the user selects “lower part” for the “store take-out (all)”, the setting unit 113 makes a setting so as to display the order images of the take-out orders in the lower part of the order display image. The display control unit 112 displays the order images of the take-out orders in the lower part of the order display image. In an example, the setting unit 113 makes a setting so as to display the order images of the in-store dining orders in the upper part of the order display image and the order images of the delivery orders in the lower part of the order display image in a divided manner. The display control unit 112 displays the order images of the take-out orders in the same area as the order images of the store delivery orders. In this case, the display control unit 112 displays the order images of the delivery orders and the order images of the take-out orders in the same area in time series based on the time when the orders are received. The display control unit 112 may display the order images of the delivery orders and the order images of the take-out orders in an identifiable display mode. For example, the display control unit 112 may display a “TO” mark in the order image of the take-out order.

For example, when the user selects the “upper part” for “in-store dining+take-out”, the setting unit 113 makes a setting so as to display the order images of the mixed orders in the upper part of the order display image. The display control unit 112 displays the order images of the mixed orders in the upper part of the order display image. In an example, the setting unit 113 makes a setting so as to display the order images of the in-store dining orders in the upper part of the order display image and the order images of the delivery orders in the lower part of the order display image in a divided manner. The display control unit 112 displays the order images of the mixed orders in the same area as the order images of the in-store dining orders. In this case, the display control unit 112 displays the order images of the in-store dining orders and the order images of the mixed orders in the same area in time series based on the time when the orders are received. The display control unit 112 may display the order images of the in-store dining orders and the order images of the mixed orders in an identifiable display mode. For example, the display control unit 112 may display a “TO” mark in the order image of the mixed order.

For example, when the user selects the “lower part” for the “in-store dining+take-out”, the setting unit 113 makes a setting so as to display the order images of the mixed orders in the lower part of the order display image. The display control unit 112 displays the order images of the mixed orders in the lower part of the order display image. In an example, the setting unit 113 makes a setting so as to display the order images of the in-store dining orders in the upper part of the order display image and the order images of the delivery orders in the lower part of the order display image in a divided manner. The display control unit 112 displays the order images of the mixed orders in the same area as the order images of the delivery orders. In this case, the display control unit 112 displays the order images of the delivery orders and the order images of the mixed orders in the same area in time series based on the time when the orders are received. The display control unit 112 may display the order images of the in-store dining orders and the order images of the mixed orders in an identifiable display mode. For example, the display control unit 112 may display a “TO” mark in the order image of the mixed order.

According to an example, the user can select the display method according to the dining type of the ordered item according to an operation style or preference of each store. The information processing apparatus does not need to change the processing of the order data according to such different preferences in order to be applied to any store.

In an example, the take-out order display selection area Ars includes the “upper part” and the “lower part” as selectable display destinations for the types of “store take-out (all)” and “in-store dining+take-out”, but possible examples are not limited thereto. The user-selectable type and display destination can be appropriately set by the administrator, the user, or the like.

An example in which the order images are divided and displayed in the upper part and the lower part of the order display image is depicted in FIG. 7, but the possible embodiments are not limited thereto. When the order images are divided and displayed, the display control unit 112 may divide and display the order images in different areas of the order display image or different display areas on separate displays or the like.

A slip printed by the printer 5 will be described. FIG. 8 is a diagram showing an example of a slip printed by the printer 5 according to an embodiment.

The printer 5 prints information on a medium such as paper based on print data output from the output unit 114, and issues the slip as depicted in FIG. 8. The slip includes a printing date and time, a slip number, a table number, a customer count, a delivery number, a commodity name of an ordered item, and the like.

The output unit 114 outputs the print data based on order data updated by the user. The output unit 114 may output the print data to the printer 5 for each piece order data, or may output the print data to the printer 5 for each ordered item included in the order data. The slip printed by the printer 5 is handed over to the store staff or the delivery person together with the ordered item, for example. The store staff or the delivery person can compare the slip with the ordered item to confirm the ordered item and the order data.

### Operation Example

Next, an operation example of the information processing system S configured as described above will be described. The particulars of the process procedure described below are merely an example, and processes may be varied from the particular example(s). Acts described for this example can be omitted, replaced, and/or added as appropriate according to other embodiments.

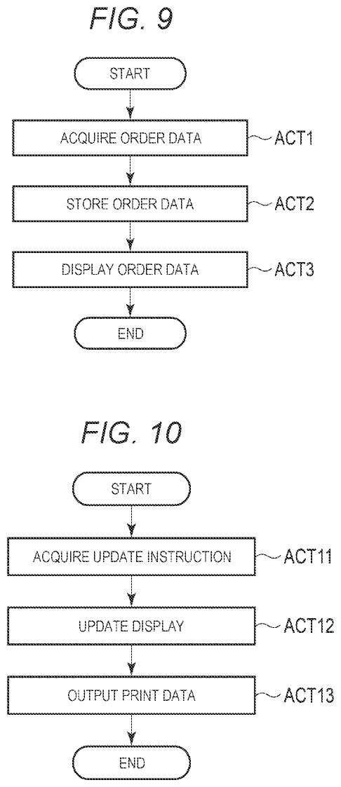

FIG. 9 is a flowchart showing an example of the order displaying executed by the store server 1.

Here, a case will be described where the store server 1 displays order images of in-store dining orders in the upper part of the order display image and order images of delivery orders in the lower part of the order display image in a divided manner based on a setting by the user.

In the following example, the store server 1 acquires order data for delivery orders and order data for first-type take-out orders from the external server 3, and acquires order data for in-store orders from various terminals connected to the store server 1. The in-store orders in this context include an in-store dining order, a second-type take-out order, and a mixed order. The display control unit 112 of the store server 1 outputs the acquired order data to the display 4. When a plurality of displays 4 are provided, the display control unit 112 may output the acquired pieces of order data to these displays 4, respectively.

The acquisition unit 110 acquires order data (ACT 1). In ACT 1, the acquisition unit 110 acquires order data for a delivery order from the external server 3. The acquisition unit 110 acquires order data for an in-store dining order from the handy terminal 8, the tablet terminal 9, or the POS terminal 7. The acquisition unit 110 may acquire order data for a first-type take-out order from the external server 3. The acquisition unit 110 may acquire order data for a second-type take-out order and order data for a mixed order from the handy terminal 8, the tablet terminal 9, or the POS terminal 7.

The storage control unit 111 stores the order data in the order data storage area 130 (ACT 2).

The display control unit 112 displays an order image in a different area of the display 4 depending on whether the order data is the order data for the in-store dining order or the order data for the delivery order (ACT 3). In ACT 3, the display control unit 112 displays an order image of the in-store dining order in the upper part of the order display image of the display 4. The display control unit 112 displays an order image of the delivery order in the lower part of the order display image of the display 4. The display control unit 112 displays the order image displayed in the upper part of the order display image and the order image displayed in the lower part of the order display image on the display 4 in a display mode in which a dining type is identifiable. For example, the display control unit 112 displays, on the display 4, an order image including a delivery number for the order data for the delivery order. The display control unit 112 may display, on the display 4, an order image including the “delivery” mark for the order data for the delivery order. The display control unit 112 displays an order image of the first take-out order, an order image of the second take-out order, and an order image of the mixed order in the upper part or the lower part of the order display image of the display 4 based on a user setting set according to an instruction of the user. The display control unit 112 may display the order image of the first take-out order, the order image of the second take-out order, and the order image of the mixed order on the display 4 in a display mode in which dining types thereof are identifiable from that of an order image based on order data of an order of another dining type. The display control unit 112 may display, on the display 4, an order image including a “TO” mark for the order data of the first take-out order, the second take-out order, and the mixed order.

FIG. 10 is a flowchart showing an example of the order display updating executed by the store server 1 according to an embodiment.

The display control unit 112 acquires an update instruction input by the user (ACT 11). In ACT 11, the display control unit 112 acquires selection of an order image and selection of an update button by the user as the update instruction. In this example, the update instruction is an update instruction for each piece of order data.

The display control unit 112 updates the order display image of the display 4 based on the update instruction (ACT 12). In ACT 12, the display control unit 112 hides the order image selected by the user. Since the order image is hidden, the display control unit 112 advances other order images in the display order and displays the images on the display 4.

The output unit 114 outputs print data based on order data to the printer 5 based on the update instruction (ACT 13). In ACT 13, the output unit 114 acquires the order data based on the order image selected by the user. The output unit 114 outputs the print data based on the acquired order data to the printer 5. The printer 5 prints a printing date and time, a slip number, a table number, a customer count, a delivery number, a commodity name of an ordered item, and the like on a medium based on the print data, and issues a slip.

### Effects

The information processing apparatus according to an embodiment can acquire (receive) order data for an order for dining, and display an image based on the order data in a first area or a second area depending on whether the order data is first order data for an order of a first dining type or second order data for an order of a second dining type. Accordingly, the information processing apparatus changes an area where the order data is displayed according to a dining type of an ordered item, thereby identifiably displaying an order image according to the dining type. Therefore, the user can more easily recognize a difference between an in-store dining order and a delivery order based on a difference between display areas of order images. In this way, the information processing apparatus can display orders such that the orders can be readily visually distinguished according to types of the orders.

The information processing apparatus according to an embodiment can display an image based on the order data displayed in the first area or the second area in a display mode by which a dining type is identifiable. Accordingly, the information processing apparatus can display the order data in different display modes according to the dining type of the ordered item. Therefore, the user can more easily recognize the difference between an in-store dining order and a delivery order based on the difference in the display mode of the order data. In this way, the information processing apparatus can display orders such that the orders can be visually distinguished according to types of the orders.

When the order data is a second order data, the information processing apparatus according to an embodiment can display an image based on the order data including unique identification information. Accordingly, the user can easily recognize the information for identifying a delivery order. In this way, the information processing apparatus can display the orders such that a delivery-type order can be visually distinguished.

When the order data is third order data for an order of a third dining type, the information processing apparatus according to an embodiment can display an image based on the order data in the first area or the second area based on a setting set according to an instruction of a user. Thus, according to selection of the user, the user can select the manner of display to more easily recognize the order including a take-out order based on a difference between the display areas. The information processing apparatus can display the orders such that the orders can be visually distinguished according to various types of the orders based on a preference in operation for each store adopting the information processing apparatus of an embodiment.

### OTHER EMBODIMENTS

An example in which the first order data, the second order data, and the third order data are displayed in the upper part or the lower part of the order display image is described in an above-described embodiment, but the present disclosure is not limited thereto. The setting unit 113 may be set so as to display order images by dividing the order display image into more than two display areas such as three areas. For example, the setting unit 113 may be set so as to display first order data in a first area, second order data in a second area, and third order data in a third area. In this case, the display control unit 112 displays an order image for the first order data in the first area, an order image for the second order data in the second area, and an order image for the third order data in the third area.

In some examples, the first area, the second area, and the third area may be on different displays. In this case, the display control unit 112 may display an order image for first order data on a first display, an order image for second order data on a second display, and an order image for third order data on a third display. The display control unit 112 may display any one of the first order data, the second order data, and the third order data on a different display. For example, the display control unit 112 may display the first order data on the first display, and the second order data and the third order data in different areas of the second display.

The information processing apparatus may be implemented by one electronic device such as the store server 1 or may be implemented by a plurality of electronic devices whose functions are distributed.

The information processing apparatus may be implemented as a display device providing the display 4. In this example, such a display device includes a processor, a main memory, an auxiliary storage device, and a communication interface substantially similar in function to the processor 11, the main memory 12, the auxiliary storage device 13, and the communication interface 14 otherwise described as provided in the store server 1. The processor of the display device implements an acquisition unit, a storage control unit, a display control unit, a setting unit, and an output unit similar to the acquisition unit 110, the storage control unit 111, the display control unit 112, the setting unit 113, and the output unit 114 implemented by the processor 11 of the store server 1. The acquisition unit implemented by the processor of such a display device may acquire order data from the store server 1.

Embodiments include not only to an electronic device, such as an information processing apparatus, but also a method executed by an electronic device. An embodiment of the present disclosure concerns a program capable of causing a computer to execute the processing of each described unit of the above-described store server 1.

Such a program may be transferred already stored in an electronic device or may be transferred in separately from the electronic device. In the latter case, the program may be transferred via a network or recorded in a recording medium. The recording medium is a non-transitory tangible medium. The recording medium is a computer-readable medium. The recording medium may be any medium that can store a program and is readable by a computer, such as a CD-ROM or a memory card.

While certain embodiments are described, these embodiments are presented by way of example only, and are not intended to limit the scope of the present disclosure. These novel embodiments can be implemented in various other forms, and various omissions, substitutions, and changes can be made without departing from the spirit of the present disclosure. The accompanying claims and their equivalents are intended to cover such forms or modifications as would fall within the scope and spirit of the present disclosure.

What is claimed is:

1. An information processing apparatus, comprising:
a first interface connectable to an external server;
a second interface connectable to a display; and
a processor configured to:
receive order data for dinning orders via the first and second interface; and
cause the display to display order data in a first area or a second area depending on whether the order data is first-type order data or second-type order data, wherein
the first and second areas are separate areas,
the first-type order data includes dining orders of a first type, and
the second-type order data includes dining orders of a second type, the second type being different from the first type.

2. The information processing apparatus according to claim 1, wherein
order data is displayed in a first display mode in the first area,
order data is displayed in a second display mode in the second area, and
the first display mode is different from the second display mode.

3. The information processing apparatus according to claim 2, wherein
the first display mode comprises a first font characteristic, and
the second display mode comprises a second font characteristic visually distinct from the first font characteristic.

4. The information processing apparatus according to claim 2, wherein
the first display mode comprises a first background characteristic, and
the second display mode comprises a second background characteristic visually distinct from the first background characteristic.

5. The information processing apparatus according to claim 2, wherein
the first display mode comprises a first background color, and
the second display mode comprises a second background color visually distinct from the first background color.

6. The information processing apparatus according to claim 1, wherein second-type order data is displayed with identification information unique to dining orders of the second type.

7. The information processing apparatus according to claim 1, wherein the processor is further configured to:
cause the display to display third-type order data in either the first area or second area depending on a preset user setting for display of the third-type order data, the third-type order data including dining orders of a third type, the third type being different from the first and second types.

8. The information processing apparatus according to claim 1, wherein the external server is a third-party ordering service server.

9. An information processing system for a restaurant, comprising:
a display;
a first interface connectable to an external server;
a second interface connectable to an in-store ordering terminal; and
a processor configured to:
receive order data for dinning orders via the first and second interface; and
cause the display to display order data in a first area or a second area depending on whether the order data is first-type order data or second-type order data, wherein
the first and second areas are separate areas,
the first-type order data includes dining orders of a first type, and
the second-type order data includes dining orders of a second type, the second type being different from the first type.

10. The information processing system according to claim 9, wherein
order data is displayed in a first display mode in the first area,
order data is displayed in a second display mode in the second area, and
the first display mode is different from the second display mode.

11. The information processing system according to claim 10, wherein
the first display mode comprises a first font characteristic, and
the second display mode comprises a second font characteristic visually distinct from the first font characteristic.

12. The information processing system according to claim 10, wherein
the first display mode comprises a first background characteristic, and
the second display mode comprises a second background characteristic visually distinct from the first background characteristic.

13. The information processing system according to claim 10, wherein
the first display mode comprises a first background color, and
the second display mode comprises a second background color visually distinct from the first background color.

14. The information processing system according to claim 9, wherein second-type order data is displayed with identification information unique to dining orders of the second type.

15. The information processing system according to claim 9, wherein the processor is further configured to:
cause the display to display third-type order data in either the first area or second area depending on a preset user setting for display of the third-type order data, the third-type order data including dining orders of a third type, the third type being different from the first and second types.

16. The information processing system according to claim 9, wherein the external server is a third-party ordering service server.

17. An information processing method for a restaurant kitchen display system, the method comprising:
receiving order data for dinning orders via a first interface and a second interface; and
causing a kitchen display to display order data in a first area or a second area of the kitchen display depending on whether the order data is first-type order data or second-type order data, wherein
the first and second areas are separate areas,
the first-type order data includes dining orders of a first type, and
the second-type order data includes dining orders of a second type, the second type being different from the first type.

18. The information processing method according to claim 17, wherein
the dining orders of the first type are delivery orders for a customer outside the restaurant, and
the dining orders of the second type are in-store orders for a customer at the restaurant.

19. The information processing method according to claim 18, wherein
order data is displayed in a first display mode in the first area,
order data is displayed in a second display mode in the second area, and
the first display mode is different from the second display mode.

20. The information processing method according to claim 17, wherein
order data is displayed in a first display mode in the first area,
order data is displayed in a second display mode in the second area, and
the first display mode is different from the second display mode.
